(19) United States
(12) Patent Application Publication
(10) Pub. No.: US 2006/0096622 A1
(43) Pub. Date: May 11, 2006

(54) Dry cleaning apparatus used to manufacture semiconductor devices

(75) Inventors: Sang-Eon Lee, Suwon-si (KR); Sun-Yong Lee, Seoul (KR); Sang-Rok Hah, Seoul (KR); Dong-Chul Heo, Gunpo-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/272,414

(22) Filed: Nov. 10, 2005

(30) Foreign Application Priority Data
Nov. 11, 2004 (KR) 2004-92020
Nov. 30, 2004 (KR) 2004-99454

(51) Int. Cl. B08B 3/00

(52) U.S. Cl. 134/94.1; 134/137; 134/149

(57) ABSTRACT

A dry cleaning apparatus for cleaning a surface of a semiconductor substrate comprises a chamber comprising a first wall and a second wall, a supporting member including a wafer receiving surface, a cleaning member for removing particles from the surface of the substrate placed on the supporting member, and a carrier gas supplying member for supplying a carrier gas and for transporting the particles separated from the surface of the substrate to the outside of the chamber, wherein the first wall of the chamber including a first portion disposed to face the wafer receiving surface and a second portion formed adjacent to the first portion and disposed to receive a part of the carrier gas supplying member.

### CROSS-REFERENCE TO RELATED APPLICATIONS

This application claims priority to Korean Patent Application No. 2004-99454, filed on Nov. 30, 2004 and Korean Patent Application No. 2004-92020, filed on Nov. 11, 2004, the disclosures of both applications are incorporated herein by reference.

### BACKGROUND OF THE INVENTION

1. Technical Field

The present disclosure relates to an apparatus for manufacturing semiconductor devices, and more particularly, to a dry cleaning apparatus for cleaning a surface of a semiconductor wafer.

2. Discussion of Related Art

A cleaning process for a semiconductor wafer surface removes residual chemicals, small particles, and contaminants that are typically produced when integrated circuits are formed on the semiconductor wafer. A wet cleaning method using a chemical solvent can be used for cleaning the wafer. The wet cleaning method includes, for example, a chemical treating process for etching or stripping contaminants on a wafer by a chemical reaction, a rinse process for rinsing chemically treated wafers using deionized (DI) water, and a dry process for drying the rinsed wafers.

The conventional wet cleaning method causes watermarks which are typically created on a wafer when a dry process is poorly performed. In conventional wet cleaning, which is a time consuming process, the chemicals used may pollute the environment.

FIG. 1 shows a conventional dry cleaning apparatus 9. The dry cleaning apparatus 9 includes a support plate 920 disposed in a chamber 900 for supporting a wafer W. A cleaning member (not shown) is disposed in the chamber 900 for removing foreign substances such as particles from a surface of the wafer W. The cleaning member may be a nozzle for injecting a high-pressure nitrogen gas onto a wafer W or a laser for generating a shock wave over a wafer surface.

A fan filter unit 940 is disposed at an upper portion of the chamber 900 for generating an ascending airstream in the chamber 900. An exhaust member 960 comprising a pump is connected to a bottom portion of the chamber 900. Using the fan filter unit 940 and the exhaust member 960, foreign substances such as particles P separated from the wafer can flow along the airstream to be exhausted from the chamber 900. Since the surface of the wafer W faces upwardly, some particles P separated from the wafer W may fall back and are re-absorbed by the wafer W.

FIG. 3 shows particles P1 and P2 attached to the wafer W before and after the cleaning process. Particles P1 represented by dotted lines are particles attached to the wafer W before the cleaning process. Particles P2 represented by solid lines are particles attached to the wafer W after the cleaning process.

### SUMMARY OF THE INVENTION

Exemplary embodiments of the present invention disclose a dry cleaning apparatus for minimizing reattachment of particles removed from a wafer.

In an exemplary embodiment of the present invention, a dry cleaning apparatus for cleaning a surface of a semiconductor substrate comprises a chamber comprising a first wall and a second wall, a supporting member including a wafer receiving surface, a cleaning member for removing particles from the surface of the substrate placed on the supporting member, and a carrier gas supplying member for supplying a carrier gas and for transporting the particles separated from the surface of the substrate to the outside of the chamber, wherein the first wall including a first portion disposed to face the wafer receiving surface and a second portion formed adjacent to the first portion and disposed to receive a part of the carrier gas supplying member.

In another exemplary embodiment of the present invention, a dry cleaning apparatus for cleaning a surface of a semiconductor substrate comprises a chamber having a gas inflow part for receiving a carrier gas, a process performing part extending from the gas inflow part for removing particles from the surface of the substrate placed on a supporting member, and a gas outflow part extending from the process performing part for transporting the carrier gas outside the chamber, a sectional area of the process performing part is smaller than a sectional area of the gas inflow part.

In still another exemplary embodiment of the present invention, a dry cleaning apparatus for cleaning a surface of a wafer comprises a chamber, a supporting member standing upright for supporting the wafer, a cleaning member for removing particles from the surface of the wafer placed on the supporting member, and a carrier gas supplying member for supplying a carrier gas into the chamber.

### BRIEF DESCRIPTION OF THE DRAWINGS

Preferred embodiments of the present disclosure can be understood in more detail from the following description taken in conjunction with the accompanying drawings.

FIG. 1 shows a conventional dry cleaning apparatus.

FIG. 2 shows the particle reabsorption occurring on the wafer shown in FIG. 1.

FIG. 3 shows particles on a wafer surface before and after a dry cleaning process is performed when the apparatus shown in FIG. 1 is used.

FIG. 4 is a cross-sectional view of a dry cleaning apparatus according to an embodiment of the present invention.

FIG. 5 is a cross-sectional view of a dry cleaning apparatus according to another embodiment of the present invention.

FIG. 6 is a cross-sectional view of a dry cleaning apparatus according to another embodiment of the present invention.

FIG. 7 shows a direction and a speed of an airstream and a flow path of foreign substances in a chamber of the dry cleaning apparatus shown in FIG. 4.

FIG. 8 is a cross-sectional view of a dry cleaning apparatus according to another embodiment of the present invention.

FIG. 9 shows a procedure of removing foreign substances from the wafer surface.

FIG. 10 is a cross-sectional view of a dry cleaning apparatus according to another embodiment of the present invention.

FIG. 11 is a cross-sectional view of a dry cleaning apparatus according to another embodiment of the present invention.

FIG. 12 is a sectional view of a dry cleaning apparatus according to another embodiment of the present invention.

FIG. 13 is a cross-sectional view showing an inner configuration of a chamber of the dry cleaning apparatus shown in FIG. 12.

FIG. 14 shows an airstream direction of a carrier gas and a flow path of foreign substances separated from a wafer in a chamber.

FIG. 15 is a cross-sectional view of a dry cleaning apparatus according to another embodiment of the present invention.

FIG. 16 is a cross-sectional view of a dry cleaning apparatus according to another embodiment of the present invention.

FIG. 17 is a cross-sectional view of a dry cleaning apparatus according to another embodiment of the present invention.

FIG. 18 shows a direction and a speed of an airstream and a flow path of foreign substances in a chamber of the dry cleaning apparatus.

FIG. 19 is a cross-sectional view of a dry cleaning apparatus according to another embodiment of the present invention.

FIG. 20 is a cross-sectional view of a dry cleaning apparatus according to another embodiment of the present invention.

FIG. 21 is a perspective view of a supporting member according to an embodiment of the present invention.

FIG. 22 is a side view of the supporting member shown in FIG. 21.

FIG. 23 is a perspective view of a semiconductor manufacturing device including a plurality of cleaning apparatuses.

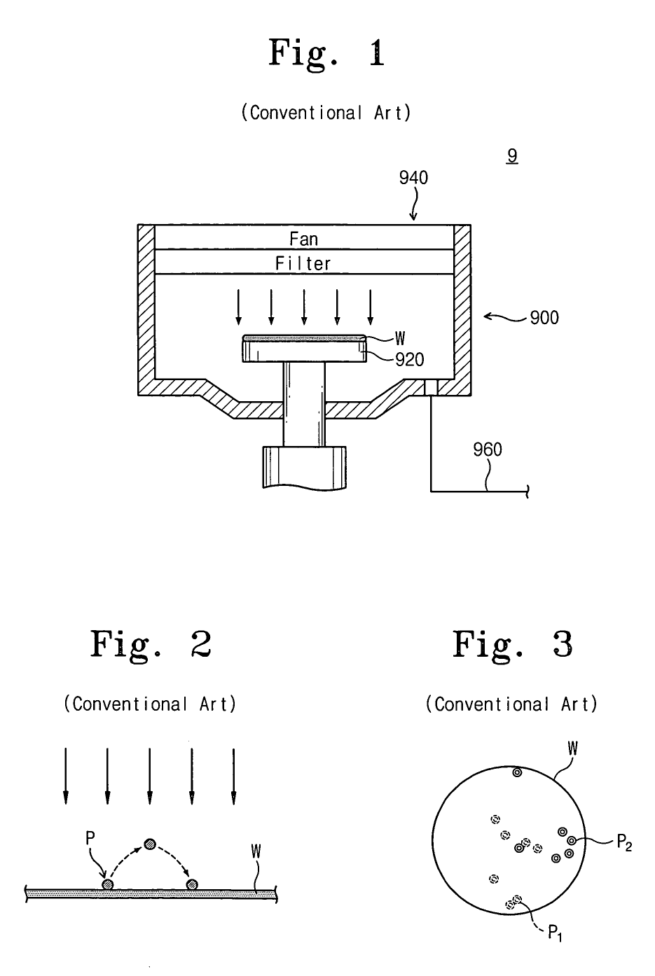

### DETAILED DESCRIPTION OF PREFERRED EMBODIMENTS

Preferred embodiments of the present invention will be described below in more detail with reference to the accompanying drawings. The present invention may be embodied in many different forms and should not be construed as limited to the embodiments set forth herein.

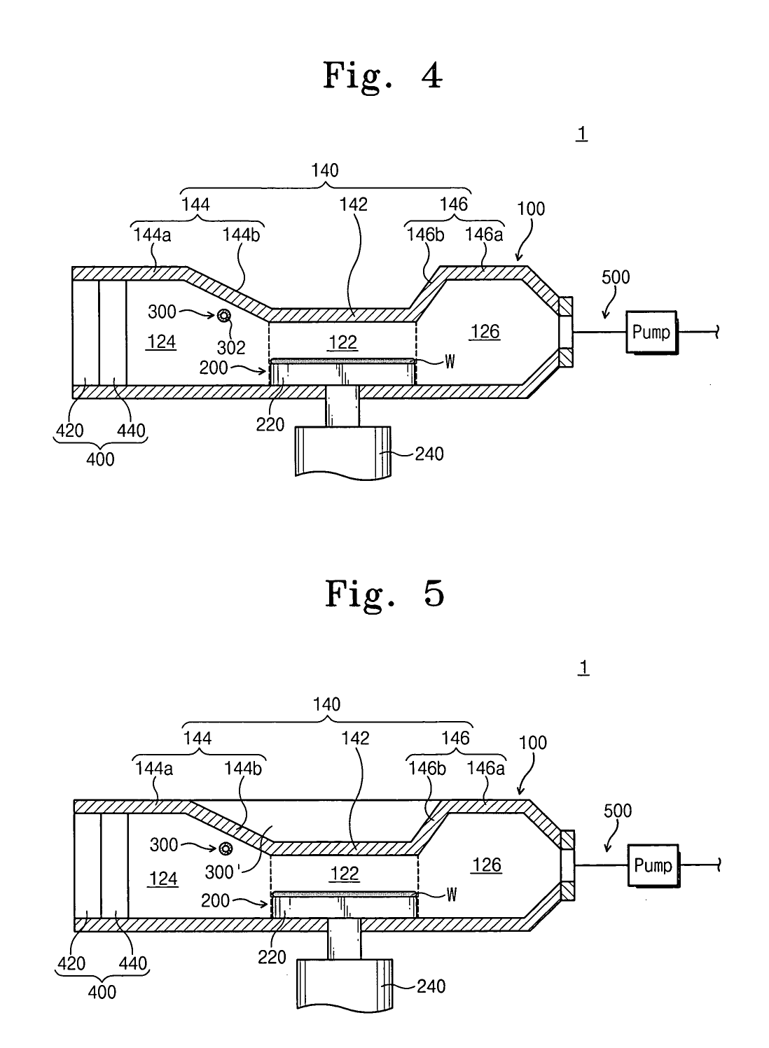

FIG. 4 shows a dry cleaning apparatus 1 according to an embodiment of the present invention. The dry cleaning apparatus 1 includes a chamber 100, a supporting member 200, a cleaning member 300, and a carrier gas supplying member 400. A dry cleaning process is performed in the chamber 100. A wafer W is disposed on the supporting member 200 in the chamber 100. The cleaning member 300 is used to remove contaminants such as particles P, residuals, or foreign substances from a surface of the wafer W. Particles P, which are separated from the surface of the wafer W, are exhausted to the outside of the chamber 100 by a carrier gas supplied from the carrier gas supplying member 400.

The supporting member 200 is disposed in or near the center of the chamber 100 and includes a support plate 220 for receiving a wafer W and a driving member 240 for rotating and/or lifting the support plate 220. The support plate 220 comprises a flat surface and is circular shaped. The support plate 220 holds the wafer W using, for example, vacuum absorption or mechanical clamping. Alternatively, the support plate 220 holds the wafer W using an electrostatic force.

A carrier gas supplying member 400 is disposed at one sidewall of the chamber 100. An exhaust member 500 is disposed at the other sidewall of the chamber 100. In an exemplary embodiment, the carrier gas supplying member 400 may be a fan filter unit comprising, for example, a fan 420 and a filter 440. Using the fan 420, a carrier gas is supplied into the chamber 100 from outside. The supplied carrier gas is filtrated by the filter 440. In the chamber 100, the carrier gas flows from one side to another side along a top surface of the wafer W. That is, the carrier gas flows horizontally in the chamber 100. The carrier gas may be dry air, nitrogen gas, an inert gas, or dry ice.

The cleaning member 300 comprises a nozzle configured for injecting a high-pressure cleaning gas onto the wafer W. The cleaning gas can be, for example, nitrogen gas or an inert gas used to minimize effects on a pattern formed on the wafer W. The effects can be, for example, a formation of a native oxide layer. The cleaning member 300 is a rod-shaped nozzle. The length of the cleaning member 300 is similar to or longer than a diameter of the wafer W. The cleaning member 300 is disposed in the chamber 100 to be substantially perpendicular to a flow direction of the carrier gas.

A plurality of injection holes 302 are formed at the cleaning member 300 and spaced apart with a regular interval. The cleaning member 300 is fixedly disposed at an inner sidewall of the chamber 100, and the driving member 240 lifts the support plate 220 upwardly close to the cleaning nozzle 300. The driving member 240 may comprise, for example, a cylinder or a motor (not shown). According to an embodiment of the present invention, the support plate 220 may be fixed and the cleaning member 300 may move in a flow direction of the carrier gas.

According to an embodiment of the present invention, a cleaning member may be a laser member 300′ shown in FIG. 5. The laser member 300′ irradiates laser beams over a surface of the wafer W to generate a shock wave to remove particles P attached to the surface of the wafer W. Alternatively, the laser member 300′ may directly irradiate laser beams to the surface of the wafer W to remove particles P. When the laser beam is directly irradiated on the wafer W, the driving member 240 lifts the support plate 220 upwardly and rotates the support plate 220.

Referring to FIG. 5, the chamber 100 includes a gas inflow part 124, a process performing part 122, and a gas outflow part 126. The process performing part 122 is disposed in or near the center of the chamber 100 where a support plate 220 is disposed. The gas inflow part 124 is a space between the process performing part 122 and a sidewall of the chamber 100 where the gas supplying member 400 is disposed. The gas outflow part 126 is a space between the process performing part 122 and a sidewall of the chamber 100 where the exhaust member 500 is disposed. According to an embodiment of the present invention, the carrier gas flows from the gas inflow part 124 to the process performing part 122 to the gas outflow part 126.

Particles P separated from the surface of the wafer W by the cleaning member 300 are transported toward an exhaust member 500 by carrier gas. The floating particles P are affected by a horizontal force generated by the flow of carrier gas and a vertical force generated by the gravity.

If the horizontal force is not sufficient enough to overcome the gravity, the foreign substances P may drop on the wafer before completely escape the surface of the wafer W. A flow rate of carrier gas can be enhanced by increasing the speed of the fan 420, which may result in generation of turbulence. The turbulence may increase power consumption.

According to an embodiment of the present invention, a shape of the chamber 100 is formed to enhance a flow rate of the carrier gas over the wafer W. For example, a sectional area of a passageway (a passageway area) of gas is formed to have different shapes at the gas inflow part 124, the process performing part 122, and the gas outflow part 126. As a result of the different shapes of each part, a flow rate of carrier gas can be changed.

According to the Bernoulli's theorem, a flow rate of fluid is inversely proportional to a sectional area of a passageway of the fluid. For example, if the passageway area of the fluid is reduced, a flow rate of the fluid increases. According to an embodiment of the present invention, a passageway area of the process performing part 122 is smaller than that of the gas inflow part 124. If a passageway area is reduced sharply or abruptly, a vortex can be generated at an area where the passageway area is reduced. At a region of the gas inflow part 124, which is adjacent to the process performing part 122, a passageway area is reduced within a scope to minimize generation of the vortex.

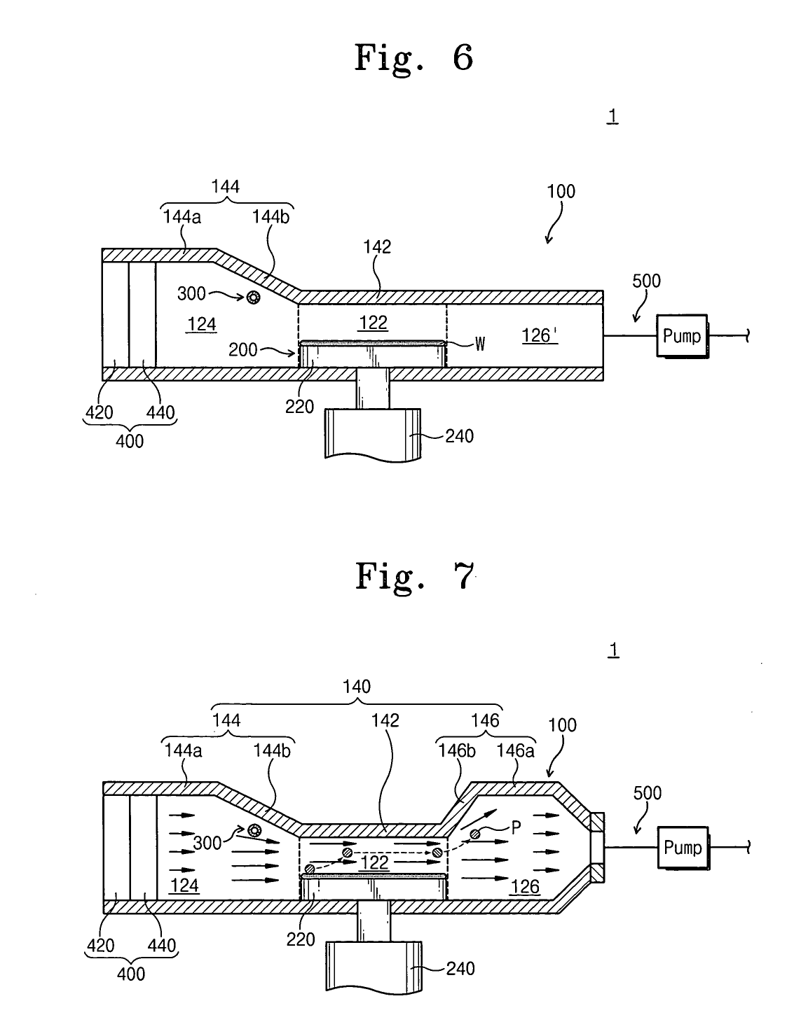

According to an embodiment of the present invention, the passageway area of the gas outflow part 126 is larger than that of the process performing part 122. A passageway of gas is upwardly widened, allowing carrier gas passing the process performing part 122 to flow horizontally or upwardly. Thus, a flow direction of the carrier gas is formed away from the wafer W so that particles P floating over the wafer W can be prevented from reattaching to the wafer W. The passageway area of the gas outflow part 126 may increase sharply or gradually. Alternatively, the passageway area of the gas inflow part 126 can be equal to or smaller than that of the process performing part 122, as illustrated in FIG. 6.

Returning to FIG. 4, an upper wall 140 includes a first portion 142 disposed over the process performing part 122, a second portion 144 disposed over the gas inflow part 124, and a third portion 146 disposed over the gas outflow part 126. The first portion 142 is lower than the second portion 144 and the third portion 146. The first portion 142 is horizontally disposed. The second portion 144 includes a horizontal portion 144a disposed to be horizontal to an area adjacent to the carrier gas supplying member 400 and a slant portion 144b disposed between the first portion 142 and the horizontal portion 144a. The slant portion 144b is formed downwardly toward the wafer W. The third portion 146 includes a horizontal portion 146a disposed to be horizontal to an area adjacent to the exhaust member 500 and a slant portion 146b disposed between the first portion 142 and the horizontal portion 146a. The slant portion 146b is formed upwardly away from the wafer W.

FIG. 7 shows directions of the airstream in different parts of the chamber 100 generated by a carrier gas. FIG. 7 also shows the speed of the airstream at respective portions in the chamber 100. FIG. 7 also shows a flow path of the particles P separated from the wafer W. In FIG. 7, lengths of arrows indicate the speed scales of the airstream.

Referring to FIG. 7, a carrier gas flows into the gas inflow part 124 at a predetermined speed using the carrier gas supplying member 400. The carrier gas is accelerated while passing the slant portion 144b of the upper wall 140. The carrier gas flows in a consistent speed over a top surface of the wafer W while passing a process performing part 122. Then, the carrier gas passes the gas outflow part 126 and is exhausted to the outside through the exhaust member 500. When the carrier gas passes the slant portion 146b of the gas outflow part 126, the carrier gas flows along the slant portion 146b.

Due to the airstream passing the process performing part 122, the particles P can be removed from the surface of the wafer W. In the process performing part 122, particles P can be removed from the wafer W and transported away from the wafer W along the airstream of the carrier gas.

When the particles P flow along the airstream in the process performing part 122, the particles P gradually descend due to gravity. Therefore, the particles removed from the wafer W may drop onto the surface of the wafer W.

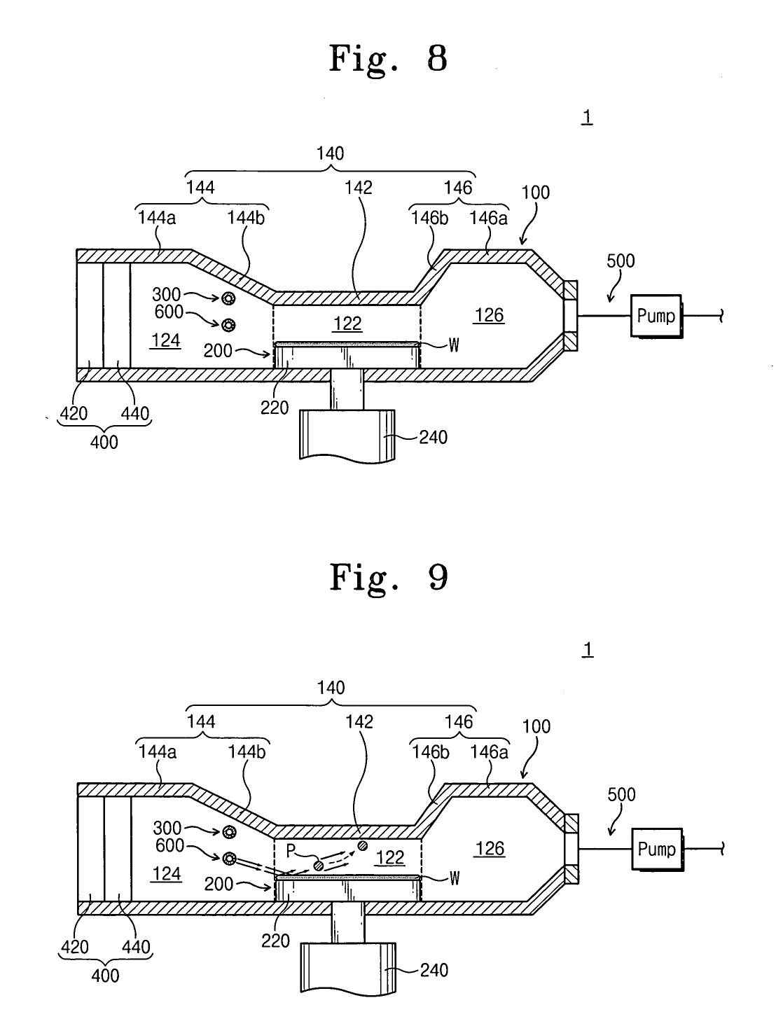

According to an embodiment of the present invention, a floating gas supplying member 600 may be included in the chamber 100 as illustrated in FIG. 8.

Referring to FIG. 8, the floating gas supplying member 600 is shaped as a nozzle configured for injecting a floating gas to a surface of the wafer W. The floating gas supplying member 600 is similar shaped to a cleaning member 300 configured for injecting a cleaning gas. The floating gas supplying member 600 may be disposed near the cleaning member 300. For example, the floating gas supplying member 600 can be disposed under the cleaning member 300.

Referring to FIG. 9, the floating gas supplying member 600 injects the floating gas to the surface of the wafer W at a lower injection pressure. An angle of the injection for the floating gas supplying member 600 is smaller than the injection angle of the cleaning member 300. After colliding against the surface of the wafer W, the floating gas flows upwardly toward the gas outflow part 126.

As illustrated in FIG. 9, after particles P separated from the wafer W by a cleaning gas, the particles P can be removed from the surface of the wafer W along the airstream of the carrier gas.

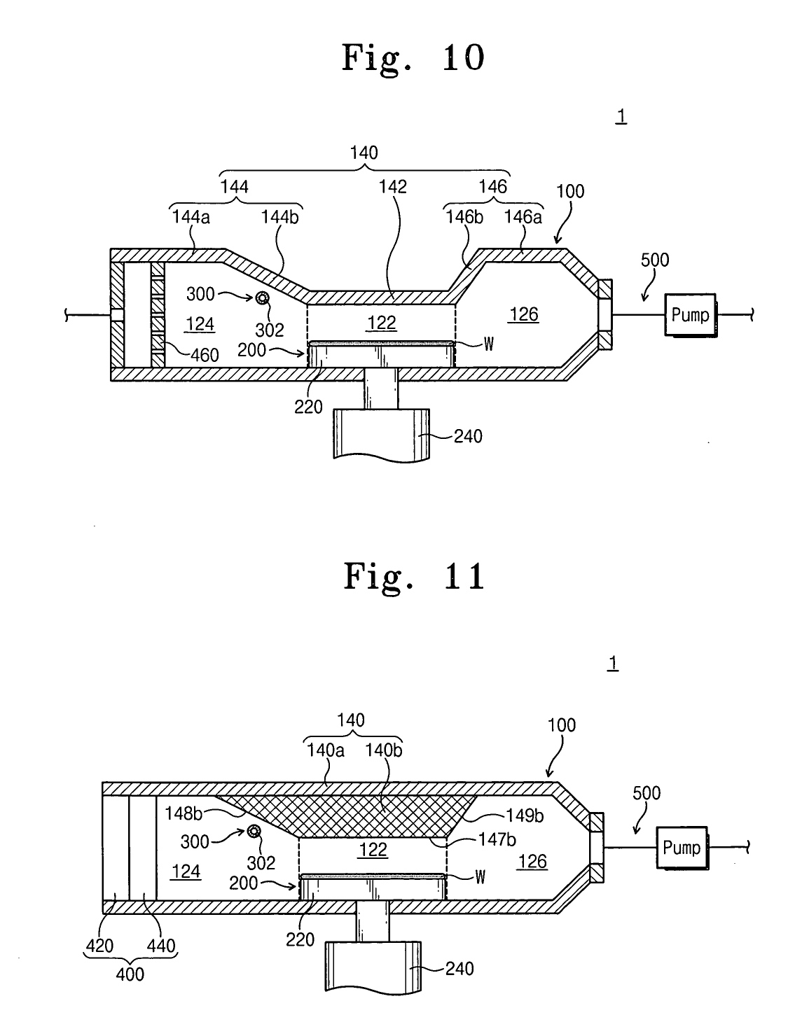

According to an embodiment of the present invention, the carrier gas may be supplied into the chamber 100 using a rod-shaped or plate-shaped injection member 460 where a plurality of injection holes are formed, as illustrated in FIG. 10. The rod-shaped or plate shaped injection member 460 may increase a flow rate of the carrier gas. Different shapes of the upper wall 140 may be provided according to embodiments of the present invention.

According to an embodiment of the present invention, as illustrated in FIG. 11, the upper wall 140 may have a flat base surface 140a and an underlying accelerating member 140b connected to the flat base surface 140a. The accelerating member 140b includes a bottom surface 147b and slanting portions 148b and 149b. The bottom surface 147b is flat and disposed over the process performing part 122.

The slant portions 148b and 149b are disposed at the gas inflow part 124 and the gas outflow part 126 and extend to be slanted upwardly from both sides of the bottom surface 147b, respectively. The slant portion 148b disposed at the gas inflow part 124 and the slant portion 149b disposed at the gas outflow part 126 may have the same slant angle or different slant angles. According to an embodiment of the present invention, the accelerating member 140b can be removably coupled with the base surface 140a.

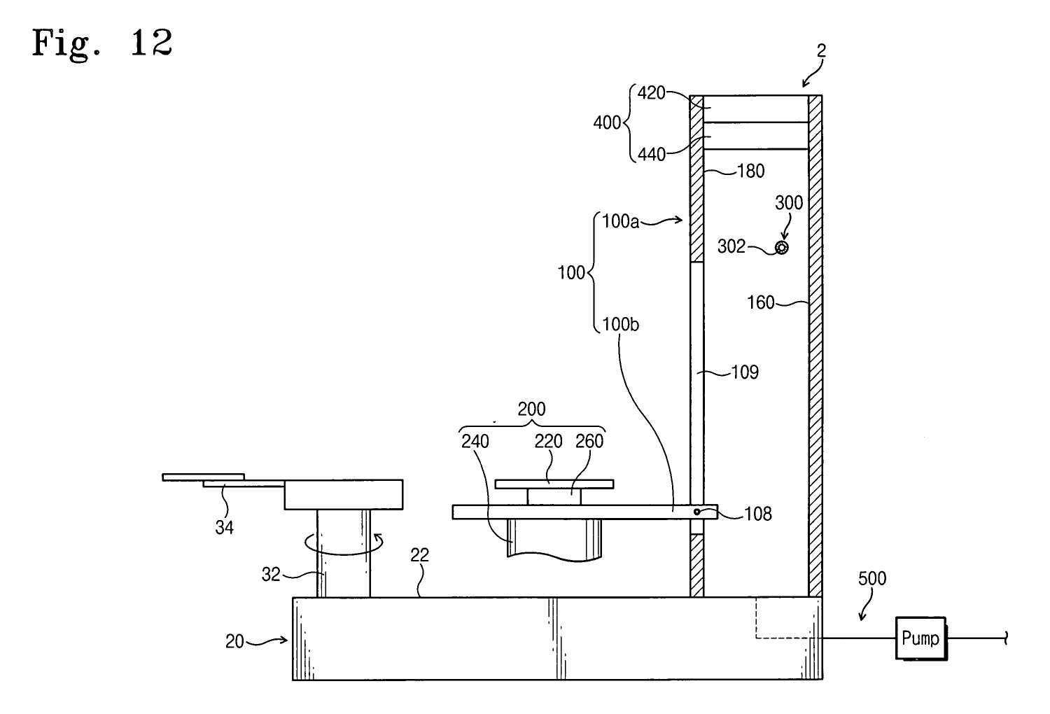

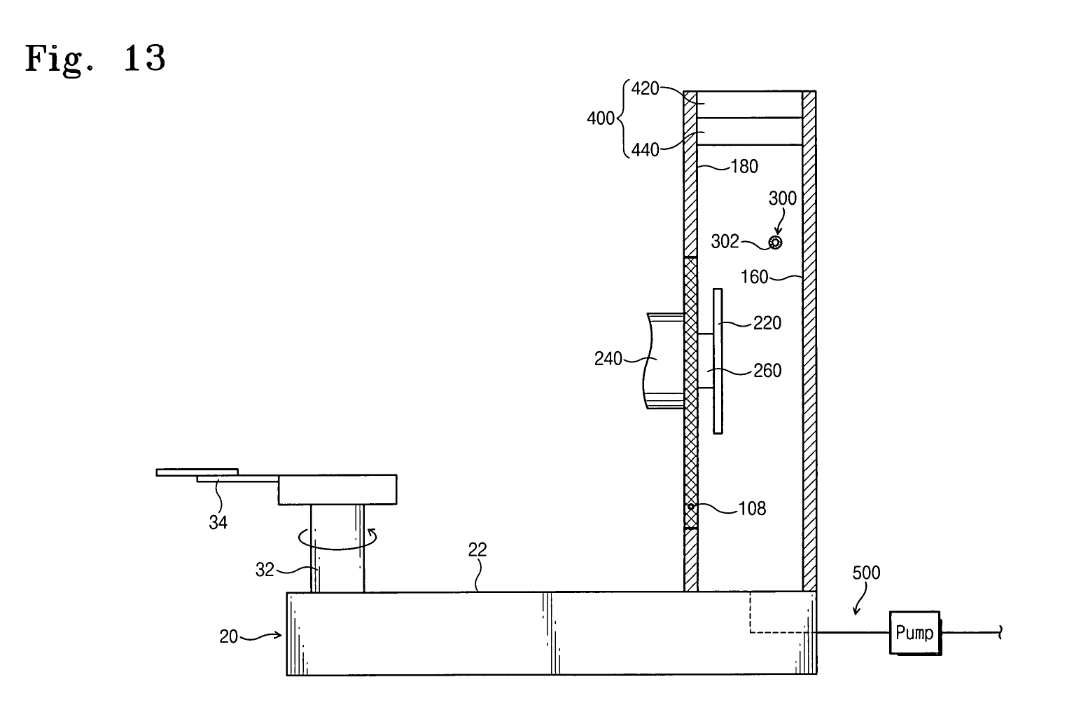

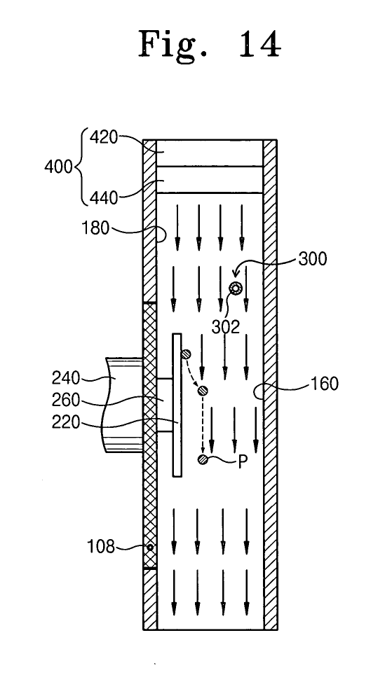

FIG. 12 and FIG. 13 illustrate a dry cleaning apparatus 2 according to another embodiment of the present invention. An opening 109 of a chamber 100 is disposed in a wall of the chamber 100. The dry cleaning apparatus 2 includes the chamber 100, the supporting member 200, the cleaning member 300, and the carrier gas supplying member 400. The supporting member 200 is disposed in the chamber 100 for supporting the wafer W. Particles P, which are separated from a surface of the wafer W are exhausted to the outside by the carrier gas supplied from the carrier gas supplying member 400.

The chamber 100 is mounted on a bottom plate 20 having a flat top surface. The chamber 100 includes a body 100a and a rotatable plate 100b. The body 100a is cuboid-shaped. The opening 109 is formed at a front wall 180 of the body 100a. The rotatable plate 100b is a rectangular plate to open and close the opening 109 of the body 100a. The rotatable plate 100b and the body 100a are coupled by, for example, a hinge 108. The rotatable plate 100b rotates with respect to the hinge 108 to change its position between a standby state and a process state. The standby state represents a state in which the opening 109 of the body 100a is opened, as illustrated in FIG. 12. In the standby state, the rotatable plate 100b is disposed in parallel with the bottom plate 20. The process state represents a state in which the opening 109 of the body 100a is closed, as illustrated in FIG. 13. In the process state, the rotatable plate 100b is disposed to be aligned parallel with a back wall 160 of the body 100a.

Referring to FIG. 12, the supporting member 200 is mounted on the rotatable plate 100b. The supporting member 200 includes the support plate 220 and a support axis 260 for supporting the support plate 220. The support axis 260 moves upwardly or downwardly, or rotates using the driving member 240. The support axis 260 is protruded upwardly from the rotatable plate 100b and is fixed to a bottom surface of the support plate 220. The support plate 220 is a disk-shaped plate. A top surface of the support plate 220 is substantially flat.

A transfer robot 30 is mounted on the bottom plate 20. The transfer robot 30 is disposed near the chamber 100 and includes a vertical rod 32 and a horizontal arm 34. The vertical rod 32 can move up and down and rotate, and the horizontal arm 34 extends from the vertical rod 32 and can move horizontally. While the rotatable plate 100b is positioned in the standby state, the transfer robot 30 receives a wafer W from a vessel and transfers the wafer W to the support plate 220. A surface of the transferred wafer W is positioned parallel to the bottom plate 20. The support plate 220 may hold a wafer W using vacuum absorption, mechanical clamping or electrostatic force.

When the wafer W is placed on the support plate 220, the support plate 220 rotates to be positioned in the process state. In the body 100a, the wafer W stands upright and is supported by the support plate 220. That is, the surface of the wafer W faces the back wall 160 of the body 100a.

According to an embodiment of the present invention, the carrier gas supplying member 400 is disposed at the upper wall of the chamber 100. The exhaust member 500 is disposed at the lower wall of the chamber 100. In an exemplary embodiment, the carrier gas supplying member 400 may comprise a fan filter unit including a fan 420 and a filter 440. A carrier gas supplied into the chamber 100 through the fan 420 can be filtrated by the filter 440. According to an embodiment of the present invention, an airstream of the carrier gas moves from an upper portion to a lower portion in the chamber 100 along a surface of the wafer W. That is, the carrier gas moves vertically within the chamber 100. The carrier gas may be dry air, nitrogen gas, an inert gas, or dry ice.

The cleaning member 300 comprises a nozzle configured for injecting a high-pressure cleaning gas onto the wafer W. The cleaning gas can be, for example, a nitrogen gas or an inert gas, which produces minimum effect on a pattern formed on a surface of the wafer W. The cleaning member 300 comprises a rod- shaped nozzle that is similar to or longer than a diameter of the wafer W. The cleaning member is disposed into the chamber 100 to be substantially perpendicular to a flow direction of the carrier gas. A plurality of injection holes 302 can be formed at the cleaning member 300 and spaced apart at a regular interval. The cleaning member 300 may be fixedly disposed at an inner sidewall of the chamber 100, and the driving member 240 may move the support plate 220 upwardly toward the cleaning member 300. The driving member 240 may comprise a cylinder or a motor. The support plate 220 may be fixed and the cleaning member 300 may move in a flow direction of the carrier gas.

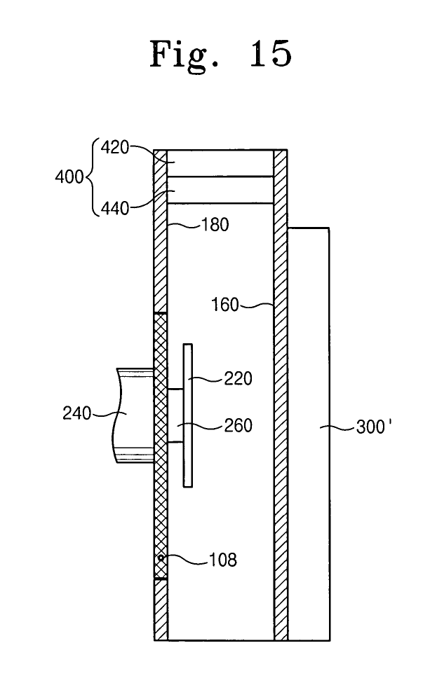

Alternatively, a laser member 300′ shown in FIG. 15 can be used as a cleaning member according to another embodiment of the present invention. The laser member 300′ is connected to the outside of the back wall 160 of the chamber 100. The laser member 300′ irradiates a laser beam between a surface of the wafer W and the back wall 160 of the chamber 100 to generate a shock wave so that particles P attached to the surface of the wafer W are removed from the wafer W. Alternatively, the laser member 300′ may directly irradiate a laser beam to a surface of the wafer W to remove the particles P. The support plate 220 can be moved upwardly and downwardly, and rotate by the driving member 240.

The particles P separated from a surface of the wafer W are moved downwardly by an airstream of the carrier gas and the gravity. When the wafer W stands upright, the particles P removed from the wafer W cannot be reattached to the surface of the wafer W.

Static electricity can be generated from the wafer W placed on the support plate 220 due to a variety of processes performed before a cleaning process. The particles P separated from the wafer W may be re-absorbed to the wafer W by the static electricity. An ionizer (not shown), to which a voltage is applied, may be disposed in a chamber to remove the static electricity.

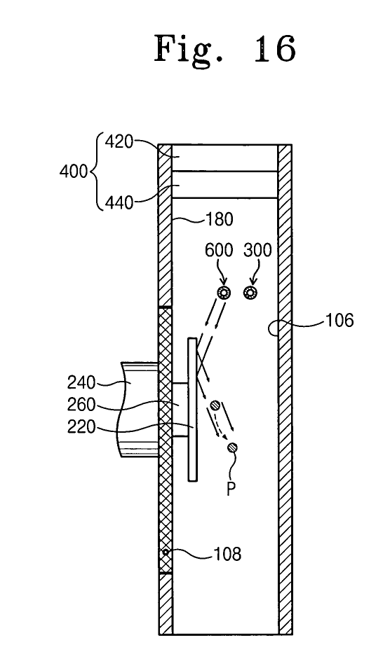

Referring to FIG. 16, the floating gas supplying member 600 is disposed in the chamber 100 to enable the foreign substances P to drop sufficiently away from the surface of the wafer W. The floating gas supplying member 600 comprises a nozzle configured for injecting a floating gas to the surface of the wafer W. The floating gas supplying member 600 is similarly shaped to the cleaning member 300 configured for injecting a cleaning gas and may be disposed adjacent to the cleaning nozzle 300 in parallel therewith as shown in FIG. 16. The floating gas supplying member 600 injects a floating gas to a surface of the wafer W at a lower injection pressure and a lower injection angle than the cleaning member 300. After colliding against the surface of the wafer W, the floating gas flows to the back wall 160. The particles P separated from the wafer W by the cleaning gas can be exhausted from the chamber 100 by the airstream of the carrier gas and by the gravity.

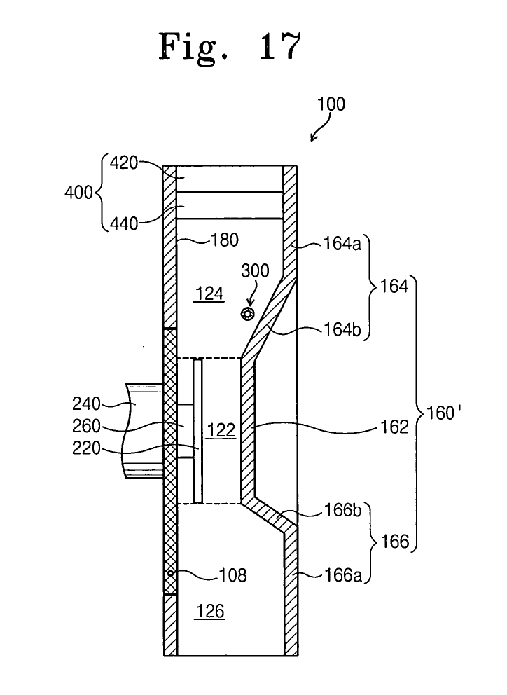

FIG. 17 illustrates a chamber 100 of a dry cleaning apparatus 1 according to another embodiment of the present invention. Particles P separated from a surface of the wafer W may be re-absorbed to the wafer W. The carrier gas streams fast in a space between the surface of the wafer W and a back wall 160 of a chamber can minimize the reabsorption of the particles P. More reabsorptions may occur when wafers W with larger diameters are used. A flow rate of carrier gas can be enhanced by increasing the speed of the fan 420. The increased speed of the fan 420 may generate turbulence, which increases, for example, power consumption.

In an exemplary embodiment of the present invention, passageway areas of the gas inflow part 124, the process performing part 122, and the gas outflow part 126 are changed by forming an upper wall 160′ in a chamber 100. Returning to FIG. 17, the upper wall 160′ includes a first portion 162 disposed at the process performing part 122, the second portion 164 disposed at the gas inflow part 124, and the third portion 166 disposed at the gas outflow part 126. The first portion 162 is lower than the second portion 164 and the third portion 166. The first portion 162 is horizontally disposed. The second portion 164 includes a vertical portion 164a disposed to be vertical to an area adjacent to the carrier gas supplying member 400 and the slant portion 164b disposed between the first portion 162 and the vertical portion 164a. The bent portion 164b is formed downwardly toward the wafer W. The third portion 166 includes a vertical portion 166a disposed to be vertical to an area adjacent to the exhaust member 500 and the slant portion 166b disposed between the first portion 162 and the vertical portion 166a. The slant portion 166b is formed upwardly away from the wafer W.

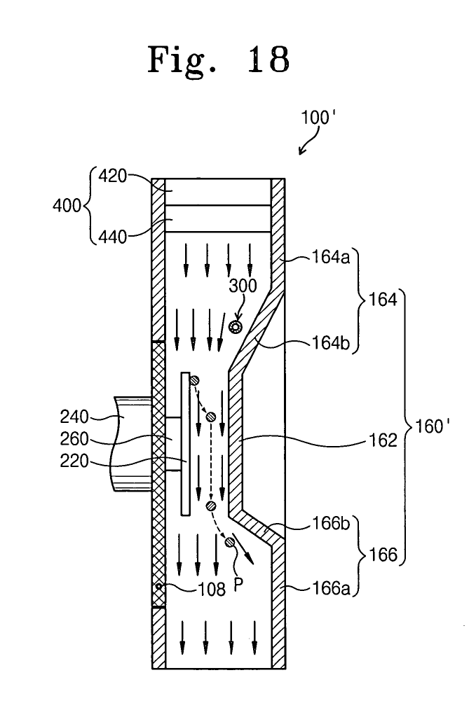

FIG. 18 shows the direction and the speed of the airstream generated by a carrier gas in the chamber 100 at respective portions of the chamber 100. The length of the arrow represents the speed of the airstream. A flow path of the foreign substances P separated from the wafer W are also shown.

Referring to FIG. 18, a carrier gas flows into the gas inflow part 124 at a predetermined speed using the carrier gas supplying member 400. The carrier gas is accelerated while passing the slant portion 164b of the upper wall 160. The carrier gas flowing over the surface of the wafer W moves faster than the carrier gas flowing into the gas inflow part 124. Afterwards, the carrier gas passes the gas outflow part 126 and is exhausted to the outside through the exhaust member 500. When the carrier gas passes below the slant portion 166b of the gas outflow part 126, the carrier gas flows along the slant portion 166b.

Returning to FIG. 17, particles P are separated from the surface of the wafer W by the cleaning member 300. Due to the airstream generated in the process performing part 122, the particles P separated from the wafer W can be transported to the gas outflow part 126.

According to an embodiment of the present invention, the carrier gas may be supplied into the chamber 100 by the rod-shaped or plate-shaped injection member 460 where a plurality of injection holes are formed to enhance the flow rate of the carrier gas.

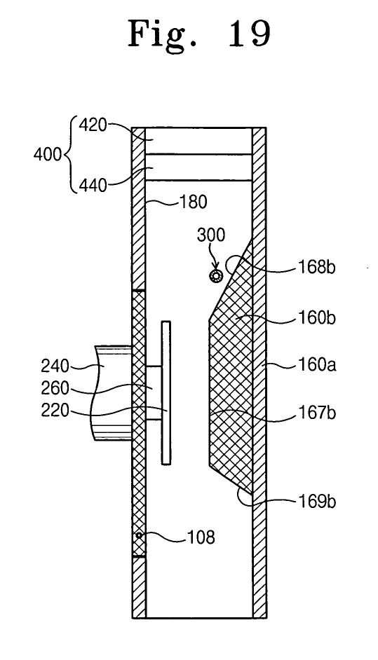

The upper wall 160 may be formed in a body to have a bent shape. Alternatively, as illustrated in FIG. 19, the upper wall 160 may have a flat base surface 160a and an underlying an accelerating member 160b connected to the base surface 160a. The accelerating member 160b has a bottom surface 167b and slant portions 168b and 169b. The bottom surface 167b is a flat surface provided to a process performing part 122. The slant portions 168b and 169b are disposed at the gas inflow part 124 and the gas outflow part 126 and extend to be inclined upwardly from both sides of the bottom surface 167b, respectively. The slant portion 168b disposed at the gas inflow part 124 and the bent portion 169b may have the same bent angle or different bent angles. The accelerating member 160b can be removably coupled with the base surface 160a.

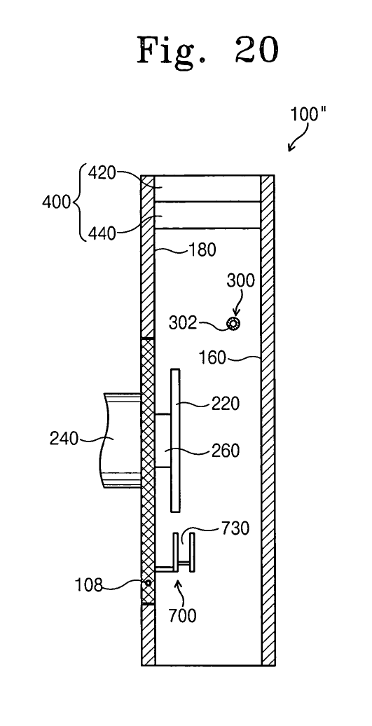

FIG. 20 shows a chamber 100″ of the dry cleaning apparatus 2 according to another embodiment of the present invention. When a cleaning process is performed using the dry cleaning apparatus 2 shown in FIG. 12, the wafer W standing upright is supported by the support plate 220 using, for example, vacuum absorption. When a process is performed, the wafer W may be slid down from the support plate 220 such that the wafer W can be damaged. A holding member 700 is disposed to prevent the damage of the wafer W by receiving the wafer W when the wafer is slid down from the support plate. The holding member 700 is mounted on the rotatable plate 100b and disposed below the support plate 220. Alternatively, the holding member 700 may be disposed in a different position such as a sidewall or a lower wall of the body.

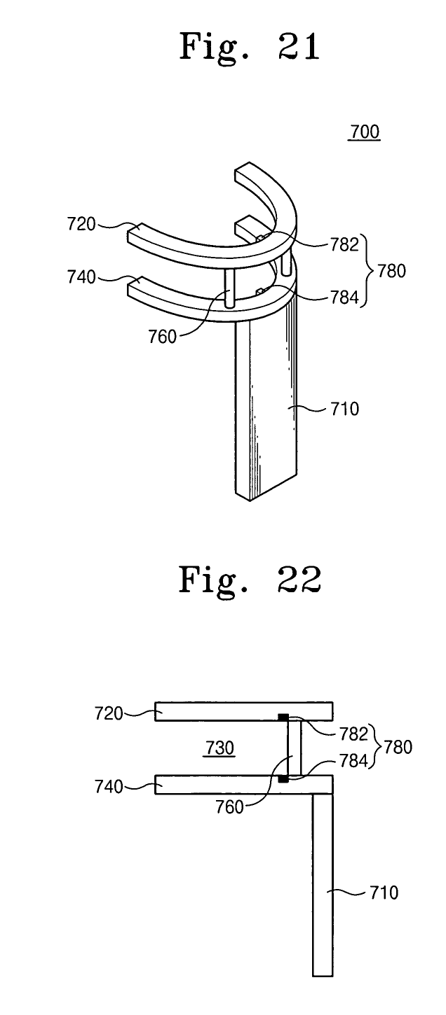

FIG. 21 is a perspective view of the holding member 700, and FIG. 22 is a side view of the holding member 700 shown in FIG. 21 according to an embodiment of the present invention.

Referring to FIG. 21 and FIG. 22, the holding member 700 includes a receiving part 730 for receiving the wafer W. The holding member 700 includes a first member 720, a second member 740, and a third member 760. The first and the second members 720 and 740 are disposed opposite and spaced apart from each other, and are connected by the third member 760. The first and the second members 720 and 740 are, for example, arch-shaped rods, and the third member 760 includes a plurality of rods which are perpendicular to the first and the second members 720 and 740.

The second member 740 is coupled with a supporting rod 710 disposed at a rotatable plate 100b. The receiving part 730 includes a space formed by the first member 720, the second member 740, and the third member 760. A wafer W slid from the support plate 220 can be stopped by the third member 760. Alternatively, the first and the second members 720 and 740 are plates, and the third member 760 may be a curved plate. The holding member 700 may comprise a material softer than the wafer W. For example, the holding member 700 may comprise polyetheretherketone or Teflon.

A sensing member 780 senses whether a wafer W is received by the holding member 700. The sensing member 780 includes a light emitting sensor 782 for irradiating light and a light receiving sensor 784 for receiving the irradiated light. The light emitting sensor 782 and the light receiving sensor 784 are positioned opposite to each other. The light emitting sensor 782 can be disposed at a side of the first member 720, and the light receiving sensor 784 can be disposed at a side of the second member 740. If the light receiving sensor 784 does not receive light, it is determined that a wafer W is slid from the support plate 220. An operator can be informed that the wafer W is slid from the support plate 220 and received by the holding member 700 by an alarm or monitor. When the wafer W is slid from the support plate 220, a process may be discontinued. Alternatively, the sensing member 780 may be a pressure sensor disposed at a side of the third member 760.

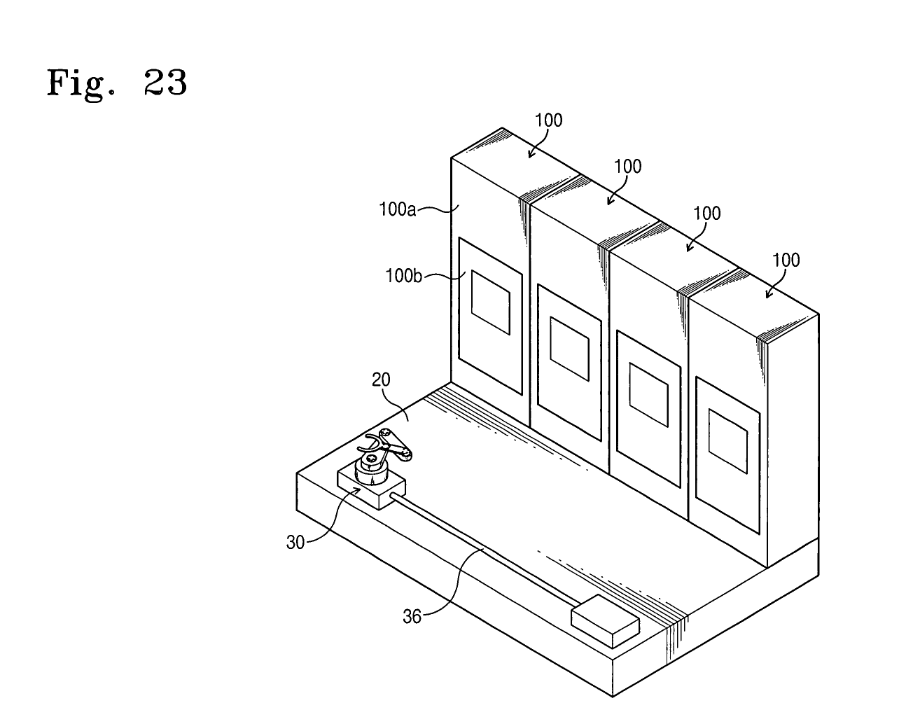

FIG. 23 illustrates equipment including a plurality of dry cleaning apparatuses according to an embodiment of the present invention. A plurality of dry cleaning apparatuses are arranged in a row. In front of chambers 100, a rail 36 is disposed over a base plate 20 to be parallel with the chambers 100. A transfer robot 30 is disposed at the end portion of the rail 36.

Although preferred embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. A dry cleaning apparatus for cleaning a surface of a semiconductor substrate, comprising:
a chamber comprising a first wall and a second wall;
a supporting member including a wafer receiving surface;
a cleaning member for removing particles from the surface of the substrate placed on the supporting member; and
a carrier gas supplying member for supplying a carrier gas and for transporting the particles separated from the surface of the substrate to the outside of the chamber, wherein the first wall of the chamber comprising a first portion disposed to face the wafer receiving surface and a second portion formed adjacent to the first portion and configured to receive a part of the carrier gas supplying member.

2. The dry cleaning apparatus of claim 1, wherein a gap between the first portion and the wafer receiving surface is smaller than a gap between the second portion and the second wall.

3. The dry cleaning apparatus of claim 1, wherein the second portion of the first wall includes a slant portion.

4. The dry cleaning apparatus of claim 1, wherein the first portion of the first wall is disposed horizontally.

5. The dry cleaning apparatus of claim 1, wherein the first wall of the chamber further includes a third portion , and wherein a gap between the first portion and the wafer receiving surface is smaller than a gap between the third portion and the second wall.

6. The dry cleaning apparatus of claim 5, wherein the third portion includes a slant portion.

7. The dry cleaning apparatus of claim 1, further comprising:
a floating gas supplying member for injecting a floating gas to the surface of the substrate placed on the supporting member.

8. The dry cleaning apparatus of claim 7, wherein the floating gas supplying member comprises a floating nozzle configured for injecting a floating gas downwardly toward the surface of the substrate placed on the supporting member.

9. The dry cleaning apparatus of claim 1, further comprising a driving member for moving the supporting member.

10. The dry cleaning apparatus of claim 9, wherein the cleaning member includes a cleaning nozzle having a plurality of injection holes configured for injecting a cleaning gas to the surface of the substrate placed on the supporting member.

11. The dry cleaning apparatus of claim 9, wherein the cleaning member further includes a laser member for irradiating a laser beam over the surface of the substrate.

12. The dry cleaning apparatus of claim 1, wherein the carrier gas supplying member comprises:
a blower fan; and
a filter unit for filtrating carrier gas.

13. The dry cleaning apparatus of claim 1, wherein the upper wall comprises:
a base surface; and
an accelerating member coupled with the bottom of the base surface at a position opposite the wafer receiving surface.

14. A dry cleaning apparatus for cleaning a surface of a semiconductor substrate, comprising:
a chamber having a gas inflow part for receiving a carrier gas;
a process performing part extending from the gas inflow part for removing particles from the surface of the substrate placed on a supporting member, and a gas outflow part extending from the process performing part for transporting the carrier gas outside the chamber; and
a sectional area of the process performing part is smaller than a sectional area of the gas inflow part.

15. The dry cleaning apparatus of claim 14, wherein the sectional area of the gas inflow part decreases gradually as the gas inflow part is close to the process performing part.

16. The dry cleaning apparatus of claim 14, wherein a sectional area of the gas outflow part is larger than that the sectional area of the process performing part, and the sectional area of the gas outflow part increases as the gas outflow part is distant away from the process performing part.

17. The dry cleaning apparatus of claim 14, wherein the gas inflow part, the process performing part, and the gas outflow part are formed by bending an upper wall.

18. The dry cleaning apparatus of claim 17, wherein the upper wall of the chamber comprises:
a base surface; and
an accelerating member coupled with a bottom of the base surface.

19. The dry cleaning apparatus of claim 14, wherein the gas inflow part receives a floating gas supplying member for injecting floating gas to the substrate placed on the supporting member.

20. A dry cleaning apparatus for cleaning a surface of a wafer, comprising:
a chamber;
a supporting member standing upright for supporting the wafer;
a cleaning member for removing particles from the surface of the wafer placed on the supporting member; and
a carrier gas supplying member for supplying a carrier gas into the chamber.

21. The dry cleaning apparatus of claim 20, wherein the chamber comprises:
a body having a sidewall where an opening is formed; and
a rotatable plate for opening and closing the opening,
wherein the supporting member is disposed at the rotatable plate, and the wafer is horizontally loaded on the supporting member when the rotatable plate is positioned to open the opening.

22. The dry cleaning apparatus of claim 21, further comprising:
a driving member, disposed at the rotatable plate, for moving or rotating the wafer on the rotatable plate.

23. The dry cleaning apparatus of claim 21, further comprising:
a holding member for receiving a wafer when the wafer is separated downwardly from the supporting member.

24. The dry cleaning apparatus of claim 23, wherein a surface of the holding member comprises a softer material than the substrate.

25. The dry cleaning apparatus of claim 23, the holding member further comprises a sensing member for sensing whether the wafer is received by the holding member.

26. The dry cleaning apparatus of claim 23, wherein the holding member comprises:
a first member;
a second member spaced apart from the first member and disposed in parallel therewith; and
a third member connecting the first member with the second member and holding the wafer.

27. The dry cleaning apparatus of claim 26, wherein the holding member further comprises:
a light emitting sensor disposed at the first member; and
a light receiving sensor disposed at the second member, wherein the light emitting sensor and the light receiving sensors are disposed opposite to each other.

28. The dry cleaning apparatus of claim 20, wherein a sidewall of the chamber includes a first portion disposed opposite to a surface of the wafer placed on the supporting member and a second portion disposed into which the carrier gas flows, and the first portion protrudes inwardly toward the body than the first portion to increase a flow rate of the carrier gas between the surface of the wafer and the second portion.

29. The dry cleaning apparatus of claim 28, wherein the second portion includes a slant portion.

30. The dry cleaning apparatus of claim 28, wherein the first portion is horizontally formed.

31. The dry cleaning apparatus of claim 28, wherein the sidewall further includes a third portion disposed in the chamber where the carrier gas flows out, the third portion includes a slant portion.

32. The dry cleaning apparatus of claim 28, further comprising:
a floating gas supplying member for injecting floating gas to the surface of the wafer placed on the supporting member.

33. The dry cleaning apparatus of claim 28, wherein the cleaning member includes a cleaning nozzle configured for injecting a cleaning gas to the surface of the wafer placed on the supporting member in the chamber, and a plurality of injection holes are formed at the cleaning nozzle.

34. The dry cleaning apparatus of claim 28, wherein the cleaning member further includes a laser member for irradiating a laser beam over the surface of the wafer.

35. The dry cleaning apparatus of claim 28, wherein the carrier gas supplying member comprises:
a blower fan; and
a filter unit for filtrating carrier gas.

36. The dry cleaning apparatus of claim 28, wherein the upper wall comprises:
a flat base surface; and
an accelerating member coupled with a bottom of the base surface.
